(19) United States
(12) Patent Application Publication
(10) Pub. No.: US 2006/0083285 A1
(43) Pub. Date: Apr. 20, 2006

(54) Lighted necklace toy with consumable portion

(76) Inventors: Lydia Lopez-Ethnasois, St. George, UT (US); Alex C. Tam, Laguna City (HK); Kami Gillmour-Bryant, Canyon Country, CA (US)

Correspondence Address: CHRISTIE, PARKER & HALE, LLP, PO BOX 7068, PASADENA, CA, 91109-7068, US

(21) Appl. No.: 11/203,397

(22) Filed: Aug. 12, 2005

Related U.S. Application Data
(63) Continuation-in-part of application No. 10/757,112, filed on Jan. 13, 2004.
(60) Provisional application No. 60/628,399, filed on Nov. 15, 2004.

(51) Int. Cl. H05B 7/06

(52) U.S. Cl. 373/93

(57) ABSTRACT

A lighted necklace toy with consumable portion having a housing containing a power source and an electrical circuit, the housing having a stem for supporting a consumable portion; an illuminating element disposed within the stem and connectable to the power source through the electrical circuit to illuminate the consumable portion; and a necklace portion attached to the housing for securing the lighted necklace toy around a neck of a user.

### CROSS-REFERENCE TO RELATED APPLICATION(S)

This application is a continuation-in-part of U.S. patent application Ser. No. 10/757,112, filed Jan. 13, 2004 and entitled LIGHTED RING TOY WITH CONSUMABLE PORTION and claims the benefit of the filing date of U.S. provisional patent application No. 60/628,399, filed Nov. 15, 2005 and entitled LIGHTED NECKLACE TOY WITH CONSUMABLE PORTION, the contents of which are hereby incorporated by reference.

### BACKGROUND OF THE INVENTION

Lighted toys containing candies or other consumable substances have been provided. However, such toys do not allow the user to wear the toy around his or her neck much like a necklace, while the candy, or other consumable substance, is lighted. Further, such toys may be rather large and complex and therefore may be expensive to manufacture.

### SUMMARY OF THE INVENTION

The present invention relates to a lighted toy that entertains a user while a consumable supported by the toy is consumed. The user activates the lighting feature of the toy by removing a circuit-interrupting insulator. Once the insulator is removed and the circuit is closed, a power source causes a light source located inside a housing to illuminate to consumable for a period of time required for the user to consume at least a portion of the consumable. The device is simple and inexpensive to manufacture.

In one embodiment, the lighted toy of the invention is a lighted necklace with a consumable portion, comprising: a housing containing a power source and an electrical circuit, the housing having a stem for supporting a consumable portion; a necklace portion connected to the housing for placing around a neck of a user; and an illuminating element disposed within the stem connectable to the power source through the electrical circuit to illuminate the consumable portion. In a further embodiment, the lighted toy further comprises a cover housing the consumable.

In a particular embodiment, the electrical circuit may have at least one electrical contact for completing the circuit in a contacting position thereof, and the ring toy may further comprise a removable insulator disposed adjacent the electrical contact in a non-contacting position to interrupt the electrical circuit. The power source may be configured to illuminate the consumable portion for a preselected period of time sufficient to consume the consumable portion, and thereafter to expire.

### BRIEF DESCRIPTION OF THE DRAWINGS

The present invention may be more readily understood from the following specification and by reference to the accompanying drawings, wherein:

FIG. 1 is an isometric view of a lighted necklace toy according to an embodiment of the present invention;

FIG. 2 is an exploded perspective view of the toy according to an embodiment of the invention shown in FIG. 1;

FIG. 3 is a vertical cross-sectional view of the toy taken along the line 3-3 of FIG. 1 according to one embodiment of the present invention;

FIG. 4 is a top plan view of a lower portion of the housing of the toy as seen in the direction 4-4 of FIG. 3;

FIG. 5 is a schematic of the electrical circuit of the lighted toy of FIG. 1 in the illustrated embodiment of the invention utilizing a flashing light emitting diode (LED);

FIG. 6 is a schematic of a configuration of the electrical circuit of the invention in another embodiment utilizing a non-flashing LED and a separate flasher circuit;

FIG. 7 is an elevational view of the lighted toy of FIG. 1 having a cover thereon, the cover shown in cross section; and

FIGS. 8A-8E illustrate alternative possible designs of the consumable according to various embodiments of the present invention.

### DETAILED DESCRIPTION OF THE INVENTION

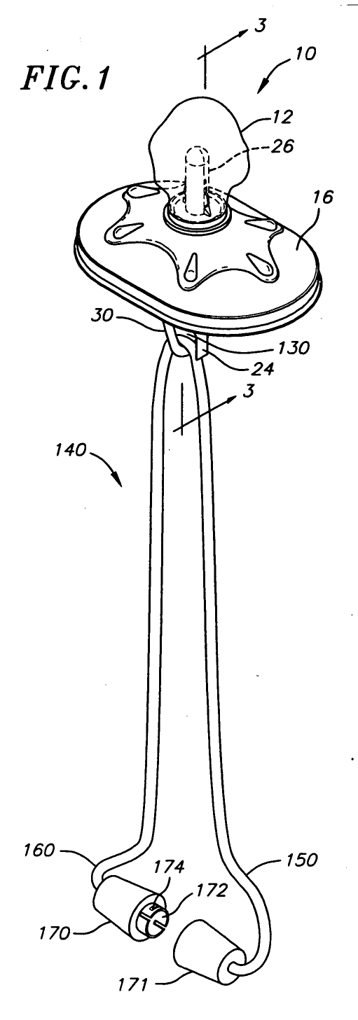

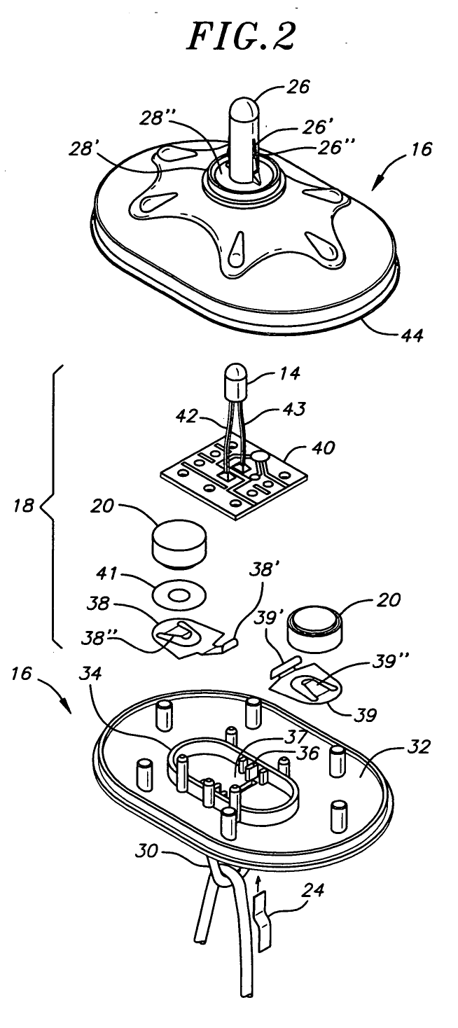

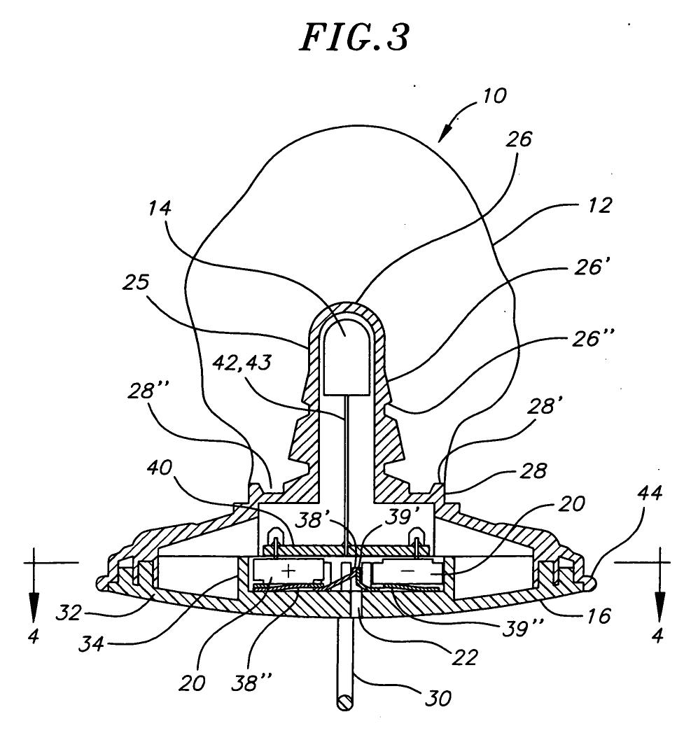

Referring now to the drawings, FIGS. 1, 2, and 3 illustrate a lighted necklace toy 10 according to one embodiment of the invention. The necklace toy 10 is constructed to be worn around a user's neck and includes a consumable 12 (FIG. 1) illuminated by a battery-powered light source 14 (FIG. 2). In the illustrated embodiment, the light source 14 is contained within a housing 16 upon which the consumable 12 is mounted. The housing 16 contains an electrical circuit 18 and a power source 20 which cause the illumination effect to occur. The housing 16 has an opening 22 (FIG. 3) through which a removable insulator 24 passes to interrupt the electrical circuit 18. Removal of the insulator 24 allows the electrical circuit 18 to be completed, creating the illumination effect of the toy and thereby amusing the user during consumption of the consumable 12 or while the consumable is worn around the user's neck.

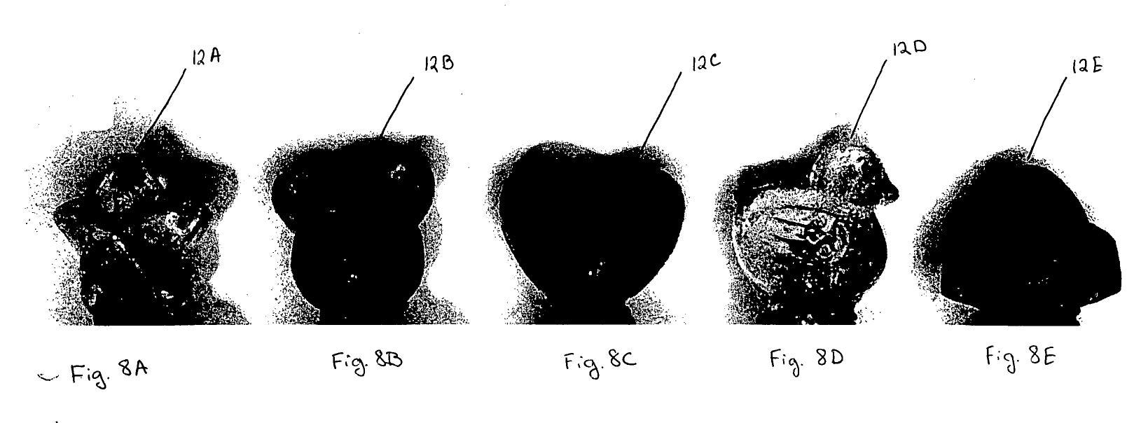

The consumable 12 mounted on the toy can be sucker candy, gummy candy, or any other food product through which illumination of the light source 14 can be seen to amuse the user. It can also have a wide variety of shapes and colors intended to amuse the user when it is illuminated. A few examples of the shapes for the consumable 12 are illustrated in FIGS. 8A through 8E and identified by the numerals 12A through 12E, respectively.

The consumable 12 has an opening 25 (FIG. 3) that receives a stem 26 of the housing 16 to hold the consumable 12 in place. The stem 26 preferably has a plurality of inclined ribs 26′ on its outer surface with undercut portions 26″ to ensure that the consumable 12 remains in place at the housing 16 during consumption or use. Alternatively, other surface structures can be employed to ensure that the consumable 12 remains in place at the housing 16 during consumption or use. When a resilient material, such as gummy candy is used for the consumable 12, the opening 25 in the consumable may be somewhat smaller in diameter than the portion of the housing to be received within it to enhance friction and thereby retain the candy in place.

The light source 14 can be a light emitting diode (“LED”) or any other suitable device for producing light in response to electrical power from the power source 20. The light source 14 can be of either the flashing or non flashing type.

Referring more specifically to FIGS. 2 and 3, in the illustrated embodiment, the stem 26 of the housing 16 contains the light source 14 and support the consumable 12. While the material of at least a part of the stem 26 is limited by the need to allow at least a portion of the light emanating from the light source to pass through it to achieve the desired visual effect, the remainder of the housing 16 is not so limited and can be made of any other suitable material.

Although the figures show a particular shape for the stem 26, alternatively, it can have any other shape suitable for supporting the consumable 12 and housing the light source 14.

Moreover, it will be understood that the stem 26 (which may also be referred to as an upwardly-extending portion) may point in any direction, including downward, when the toy is being used or consumed. For example, according to one embodiment of the invention, shown in FIG. 1, the toy is to be worn around the user's neck, whereby the stem 26 will point downward. The term “upwardly-extending portion” may be used for ease of reference to the Figures, wherein the stem 26 of the housing 16 is shown in an upwardly-extending position.

As shown in FIG. 2, the housing may be made of two different parts joined together to contain the power source 20, the electrical circuit 18, and the light source 14 of the toy 10. These two parts can be joined together by a snapping structure, by an adhesive, by combination thereof or by any other suitable method. In the embodiment shown in FIG. 3 the top portion of the housing 16 has an outer lip 44, for joining with the lower portion of the housing 16. Referring to FIG. 3, in the illustrated embodiment, the housing 16 includes a boss 28 at the base of the stem 26 for supporting the consumable 12. The boss 28 has a peripheral lip 28′ that engages the outer edge of the consumable 12, giving the combination a pleasing, uniform appearance and securing the consumable 12 to the housing 16. In some cases, an interior void 28″ is provided adjacent the base of the stem 26 to permit contraction of the candy upon curing. The housing 16 can be shaped in any way that provides sufficient space for the electrical circuit 18, the power source 20, and the light source 14. The embodiment shown in the drawings comprises a form of an elliptical pyramid whose vertex is replaced by the stem 26 of the housing 16. This gives the housing an enlarged lateral dimension.

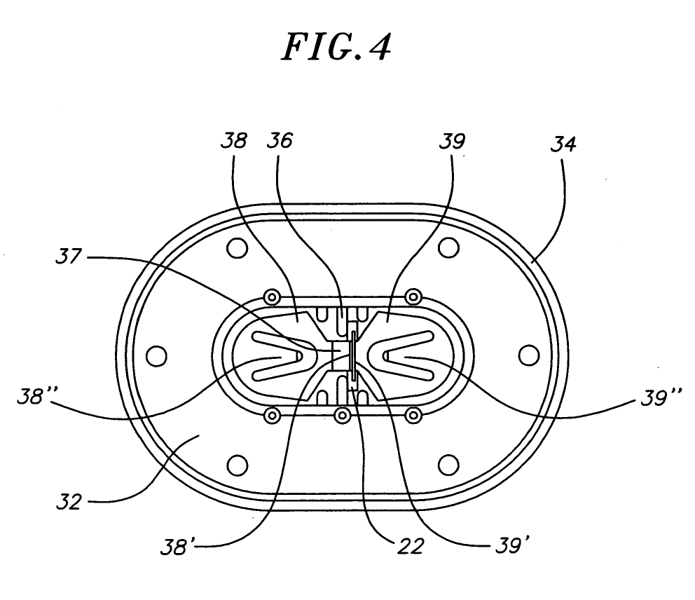

A loop portion 30 of the embodiment shown in the Figures extends from the bottom of the housing 16. The bottom of the housing 16 includes a horizontal plate 32 that joins with the remainder of the housing to support the electrical circuit 18 and the power source 20. A race track shaped abutment 34 extends upward from the horizontal plane 32 to hold in place the power source 20, represented in the drawings by two button cell batteries. The abutment 34 includes two inward extensions 36 (FIG. 4) that create a pair of recesses for receiving the button cell batteries, and a narrow gap 37 (FIGS. 2 and 4) along the floor of the plate 32.

As seen in FIG. 4, first and second contact portions 38 and 39 are disposed within the recess directly below the batteries. The first contact portion 38 has a finger 381 which extends through the gap 37 to the vertical tab 391 of the second contact portion 39. The two contact portions are also provided with central spring arms 38″ and 39″, respectively, which urge the batteries upwardly. The finger 381 of the contact portion 38 is configured to make contact with the tab 391 of the contact portion 39 when the insulator 24 is removed from the opening 22.

In the embodiment shown in the figures, the button cell batteries are disposed in opposite directions so that they are connected in series with each other and with the light source 14 when the first contact portion 38 touches the second contact portion 39. To avoid shorting out the battery terminals, an insulator ring 41 of insulating material is disposed underneath the inverted battery along its peripheral edge. The light source 14 is connected to the batteries by leads 42 and 43, which pass through and are attached to a small circuit board or wiring board 40 for support. The ends of the leads 42 and 43 extend from, or pass through, the bottom of the circuit board 40 where they make electrical contact with opposite poles of the two batteries. The electrical circuit 18, therefore, comprises the light source 14, the power source 20, the first and second contact portions 38 and 39, and the leads 42 and 43.

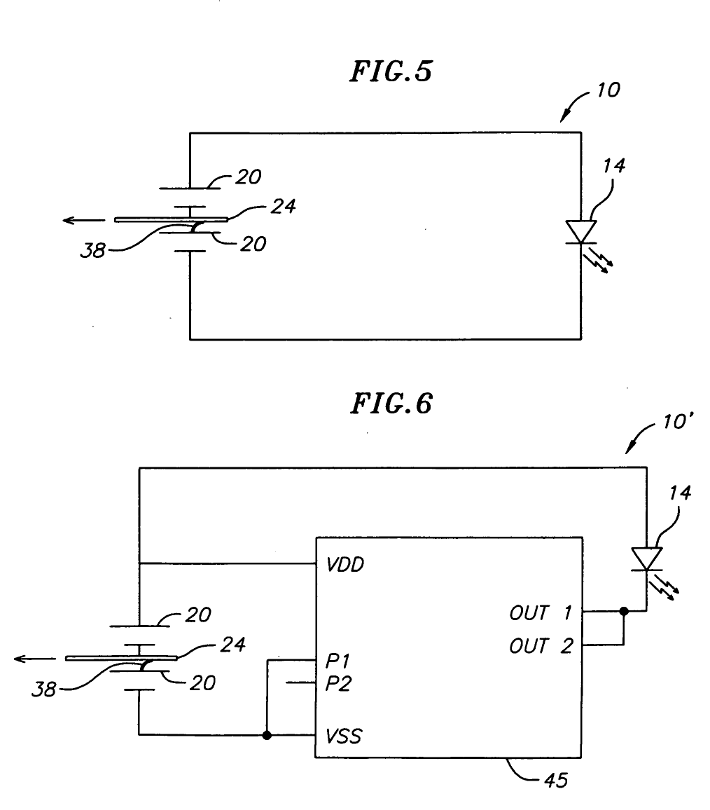

The board 40 can vary in complexity in different embodiments of the invention. In the embodiment of FIGS. 1-3 the board 40 merely anchors the leads 42 and 43 and support the light source 14. In that case, the schematic of the lighted ring toy 10 can be as illustrated in FIG. 5. The light source 14 may then be a flashing LED of the type available under the commercial designation MT-F406, which is powered by two series-connected batteries of the type identified commercially as 392A LR41 button cells. In This embodiment, the LED 14 is connected across the series-connected batteries 20 such that the removal of the insulator strip 24 in the direction indicated will complete the circuit and cause the LED to flash until the batteries are discharged.

According to the schematic of FIG. 6, which depicts an alternative embodiment of the invention (10′), the board 40 may comprise a circuit 45 that provides, in addition to physical support, lighting effects such as flashing of the light source 14. In this embodiment, the circuit 45 may be an integrated circuit of the type available commercially under designation A5403-01 which, in the illustrated configuration, intermittently applies the voltage of the batteries 20 across the LED 14 to produce a flashing light effect. Accordingly, in this embodiment, the light source can be a non-flashing LED available commercially under the designation 3R4SDB-4.

Now considering the battery circuit in greater detail, the negative terminal of each button cell battery is the discrete circular terminal on one of its ends, and the positive terminal includes the sides and bottom surfaces of the battery. One battery is inverted relative to the other, and the central spring arm 38″ of the contact portion 38 contacts the negative terminal of the inverted battery, while the positive terminal is separated from the contact portion 38 by the insulator ring 41. In this configuration, the finger 38′ of the first contact portion 38 is urged toward the tab 39′ of the second contact portion 39, which is in contact with the positive terminal of the non-inverted battery, but is initially prevented from contacting it by the insulator 24. Removal of the insulator 24 allows the finger 38′ to touch the tab 39′, completing the circuit to apply the combined voltages of the two batteries across the leads of the light source 14.

The contact portions 38 and 39 may be made of copper, steel or other resilient conductive material, causing the finger 38′ to press against the insulator 24 with sufficient force to hold it in place, while, at the same time, permitting the insulator 24 to be removed by manually pulling it downwardly from the housing 16, in the direction opposite to the stem 26. In one embodiment, the first elongated contact portion 38 is rounded or bent at its point of contact with the insulator 24 so that the insulator 24 can be removed without tearing or becoming jammed in the housing 16.

The insulator 24 and the insulator ring 41 may be made of any suitable insulating material, such as coated paper or a sheet of suitable synthetic polymeric material. In one particular embodiment, the material may be the type available commercially under the trademark Mylar.

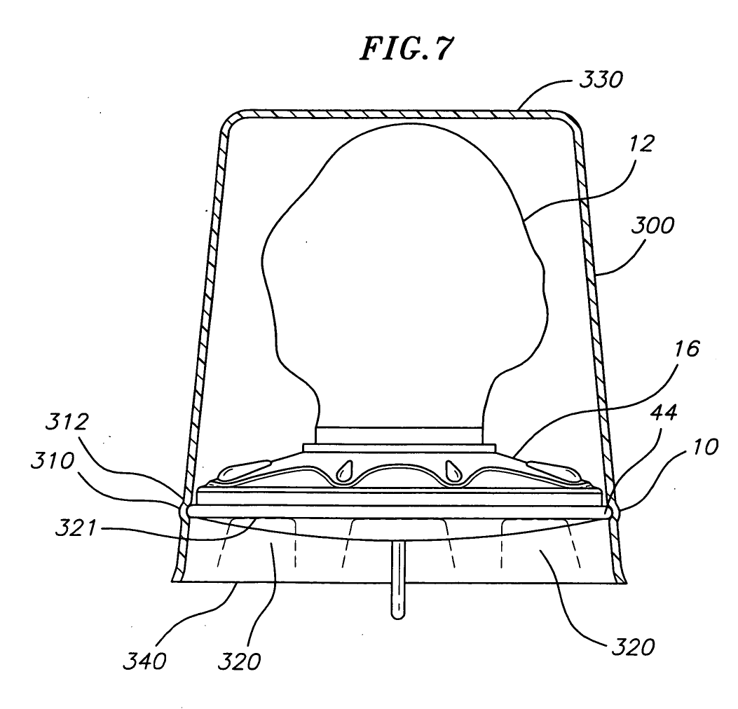

In a further embodiment, shown in FIG. 7, a cover 300 is provided for connecting with the housing 16 and, thereby, reducing the likelihood of consumable 12 becoming dirty from contact with various objects. The bottom portion of the cover 300 contains grooves 310 and notches 312 for engaging with the lip 44 of the housing 16. The lower portion of the cover 300 further contains at least two indents 320, on which the bottom of the housing 16 can rest when the cover 300 is placed over the consumable 12. In this manner, the lip 44 of the housing 16 is secured in the grooves 310 between the notches 314 and the top portions 321 of the indents 320. The top 330 of the cover 300 is adjacent to the top of the consumable 12.

The cover 300 can be made of any suitable material, such as plastic, and is of a generally cylindrical shape; however, the area of the top 330 is smaller than the area of a bottom side 340. The bottom side 340 is open to receive the toy; while the top 330 is closed. In this manner, when the cover is 300 is in place, a closed space is formed by the bottom of the housing 16, the sides of the cover 300, and the top 330, said space housing the consumable 12.

As shown in FIGS. 1 and 2, the loop portion 30, according to the shown embodiments, extends from the bottom of the housing 16. The loop portion 30 forms an opening 130 with the bottom of the housing 16. In the shown embodiments, the loop portion 30 is generally of shaped as a letter U or an inverted bell. Alternatively, the loop portion 30 can be of any shape to form an opening with the bottom of the housing 16.

Referring now to FIGS. 1 and 2, the opening 130 formed by the loop portion 30 and the bottom of the housing 16 receives a necklace 140. The necklace can be made of a string, a piece of small rope or a cord, a small chain, a plastic or rubber string or lace, or any other material suitable for making an inexpensive necklace. In the shown embodiment, the necklace 140 has a first end 150 and a second end 160. Thus, one of the ends 150 or 160 of the necklace 140 can be passed through the opening 130, thereby securing the necklace 140 in the opening 130, or, in other words, hanging the housing 16 by means of the loop portion 30 onto the necklace 140.

Two buckles 170 and 171 are affixed to the ends of the necklace 140 for attaching the ends of the necklace to each other. In the shown embodiment, FIG. 1, the buckles 170 and 171 are generally of a hollow bell shape, the open ends of the “bells” facing each other. The buckle 170 is a “male” portion, and the buckle 171 is a “female” portion. The end of the mail buckle 170 has a semi-cylindrical protrusion 172 for insertion into the interior opening of the female buckle 171. The semi-cylindrical protrusion 172 is comprised of two portions, each portion having a nub 174 at its end. The nubs 174 of the buckle 172 engage the interior of the buckle 171 by “snapping past” the edge of the buckle 171. Thus, the buckles 170, 171 interlock by inserting a semi-cylindrical protrusion 172 of the buckle 170 into the interior opening of the buckle 171, snapping the nubs 174 past the edge of the buckle 171. The nubs 174 force the semi-cylindrical protrusions 172 to become biased inwardly. The friction between the nubs 174 and the inside of the buckle 171, as well as the force formed by the inward deformation of the protrusions 172, ensure that buckles 171, 172 of the necklace 140 remain connected, unless some force is applied to disengage the two ends 150, 160 of the necklace 140. With the buckles 170 and 171 interlocked, the first end 150 and the second end 160 are joined so that the necklace 140 can be worn around the neck of the user. In alternative embodiments, the two ends of the necklace 140 can be fastened by any other means, such as, for example a conventional jewelry clasp, a fastener, a latch, or simply a tied knot. It will be appreciated by those skilled in the art that any feasible method of fastening the two ends 150, 160 of the necklace 140 which would allow the necklace 140 and the toy hanging on it to be worn around the user's neck can be used.

In order to operate the invention according to the embodiment shown in FIG. 1, the user places the necklace 140 around his or her neck and pulls the tab 24 to activate the lighting effect. The user can remove the cover 300 and consume the edible or consumable portion 12, or the user can wear the necklace 140 with the consumable portion 12 lit by the lighting effect. The user can be a child, a teenager, or a playful adult, and the necklace toy can also be placed around the necks of toy dolls or pets for amusement.

The preceding description has been presented with reference to presently preferred embodiments of the invention. These should not be construed as limitations on the scope of the invention, but rather, as examples of the embodiments thereof. Alterations and changes in the described structure may be practiced without meaningfully departing from the scope and spirit of the invention.

For example, the circuit board 40 may, in its more complex embodiments, take the form of a printed circuit board having discrete electronic components mounted thereon, an integrated circuit, or a hybrid circuit comprising both discrete components and one or more integrated circuits. Accordingly, the scope of the invention should be determined not by the embodiments illustrated, but by the appended claims and their equivalents.

What is claimed is:

1. A lighted necklace toy with consumable portion comprising:
a housing containing a power source and an electrical circuit, the housing having a stem for supporting a consumable portion;
an illuminating element disposed within the stem and connectable to the power source through the electrical circuit to illuminate the consumable portion; and
a necklace portion attached to the housing for securing the lighted necklace toy around a neck of a user.

2. The lighted necklace toy of claim 1 wherein the stem allows at least a portion of the light from the illuminating element to pass through it.

3. The lighted necklace toy of claim 1 wherein:
the electrical circuit has at least one electrical contact for completing the electrical circuit in a contacting position thereof, and
the lighted necklace toy further comprises a removable insulator disposed adjacent the electrical contact in a non-contacting position to interrupt the electrical circuit.

4. The lighted necklace toy of claim 3 wherein the at least one electrical contact comprises a resilient electrical conductor mechanically biased relative to the power source to complete the electrical circuit in said contacting position thereof.

5. The lighted necklace toy of claim 3 wherein the power source is configured to illuminate the consumable portion for a preselected period of time sufficient to consume at least a portion of it, and thereafter to expire.

6. The lighted necklace toy of claim 3 wherein the removable insulator is made of coated paper.

7. The lighted necklace toy of claim 3 wherein the removable insulator comprises a synthetic polymeric material.

8. The lighted necklace toy of claim 7 wherein the removable insulator comprises Mylar.

9. The lighted necklace toy of claim 1 wherein a circuit board is integrated into the electrical circuit to cause the illuminating element to flash.

10. The lighted necklace toy of claim 8 wherein the circuit board includes at least one integrated circuit configured as a flasher.

11. The lighted necklace toy of claim 1 wherein the illuminating element is an LED of the flashing type.

12. The lighted necklace toy of claim 1 wherein the necklace portion comprises a necklace and at least one of a first buckle and a second buckle, a clasp, a fastener, a latch, and a tied knot for fastening the necklace.

13. The lighted necklace toy of claim 1 further comprising a cover for placing over the consumable portion, the cover being removable attachable to the housing.

14. The lighted necklace toy of claim 1 further comprising a loop portion extending from the housing for attaching the necklace portion to the housing.
